(19) United States
(12) Patent Application Publication
(10) Pub. No.: US 2022/0235580 A1
(43) Pub. Date: Jul. 28, 2022

(54) LOCK ASSEMBLY

(71) Applicant: ASSA ABLOY NEW ZEALAND LIMITED, North Shore City (NZ)

(72) Inventor: Konghua QIN, Zhongshan City (CN)

(21) Appl. No.: 17/609,070

(22) PCT Filed: May 8, 2020
(86) PCT No.: PCT/NZ2020/050047

§ 371 Date: Nov. 5, 2021

(30) Foreign Application Priority Data
May 9, 2019 (CN) 201910386850.2

(51) Int. Cl. E05B 63/00; E05B 15/00

(52) U.S. Cl. CPC E05B 63/0021; E05B 63/08; E05B 15/0013

(57) ABSTRACT

A lock assembly, comprising: a lock cylinder comprising a cam; a deadbolt comprising a first cam follower and a second cam follower, each of the first cam follower and the second cam follower being configured to receive the cam; wherein rotation of the lock cylinder in a first rotational direction causes the cam to communicate with the first cam follower to drive the deadbolt from a retracted position to a first extended position, and further rotation of the lock cylinder in the first rotational direction causes the cam to com- municate with the first cam follower to drive the deadbolt from the first extended position to a second extended position; wherein rotation of the lock cylinder in a second rotational direction opposite to the first rotational direction causes the cam to communicate with the second cam follower to drive the deadbolt from the second extended position to the first extended position, and further rotation of the lock cylinder in the second rotational direction causes the cam to communicate with the first cam follower to drive the deadbolt from the first extended position to the retracted position.

### FIELD

This relates to a lock assembly for a panel, such as a door or a window.

### BACKGROUND

Panels, such as doors or windows, often have a lock assembly which allows the panel to be locked. This can impede the door being used by an unauthorised person. For example, a lock assembly may require a suitable key to be inserted and turned before the door can be opened. Some lock assemblies have a latch for providing a first point of locking and a deadbolt for providing a second point of locking.

### SUMMARY

In a first example embodiment, there is provided a lock assembly, comprising: a lock cylinder comprising a cam; a deadbolt comprising a first cam follower and a second cam follower, each of the first cam follower and the second cam follower being configured to receive the cam; wherein rotation of the lock cylinder in a first rotational direction causes the cam to communicate with the first cam follower to drive the deadbolt from a retracted position to a first extended position, and further rotation of the lock cylinder in the first rotational direction causes the cam to communicate with the first cam follower to drive the deadbolt from the first extended position to a second extended position; wherein rotation of the lock cylinder in a second rotational direction opposite to the first rotational direction causes the cam to communicate with the second cam follower to drive the deadbolt from the second extended position to the first extended position, and further rotation of the lock cylinder in the second rotational direction causes the cam to communicate with the first cam follower to drive the deadbolt from the first extended position to the retracted position.

### BRIEF DESCRIPTION OF DRAWINGS

The invention is described by way of example with reference to the drawings, which show some embodiments of the invention. However, these are provided for illustration only. The invention is not limited to the particular details of the drawings and the corresponding description.

FIG. 1 shows a lock assembly according to an example embodiment.

FIG. 2 shows a front isometric view of the lock assembly.

FIG. 3 shows a back isometric view of the lock assembly.

FIG. 4 shows a front view of the lock assembly with the deadbolt in a retracted position.

FIG. 5 shows a partial front view of the lock assembly with the deadbolt in the retracted position to show the first cam follower and second cam follower.

FIG. 6 shows a rear view of the lock assembly with the deadbolt in a retracted position.

FIG. 7 shows the lock assembly with the deadbolt transitioning between the retracted position and a first extended position.

FIG. 8 shows a front view of the lock assembly with the deadbolt in the first extended position.

FIG. 9 shows a partial front view of the lock assembly with the deadbolt in the first extended position to show the first cam follower and second cam follower.

FIG. 10 shows a rear view of the lock assembly with the deadbolt in the first extended position.

FIG. 11 shows the lock assembly with the deadbolt transitioning between the first extended position and the second extended position.

FIG. 12 shows a front view of the lock assembly with the deadbolt in the second extended position.

FIG. 13 shows a partial front view of the lock assembly with the deadbolt in the second extended position to show the first cam follower and second cam follower.

FIG. 14 shows a rear view of the lock assembly with the deadbolt in the second extended position.

FIG. 15 shows the lock assembly with a deadbolt restrictor in the restricted position and the deadbolt in the retracted position.

FIG. 16 shows the lock assembly with the deadbolt restrictor in the restricted position and the deadbolt in the first extended position.

### DETAILED DESCRIPTION

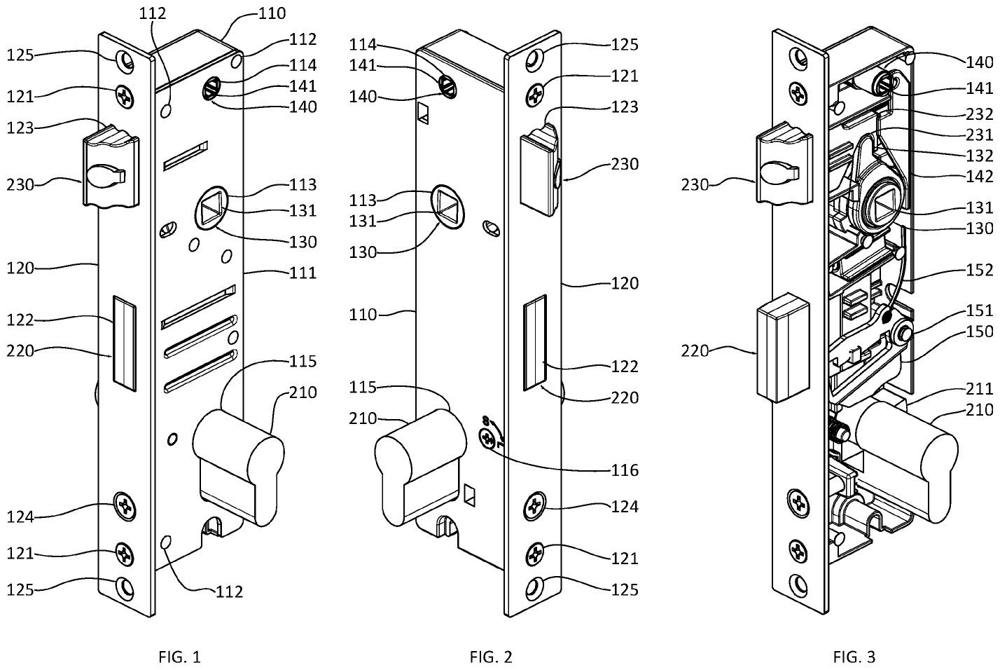

A lock assembly according to an example embodiment is shown in FIGS. 1 and 2.

The depicted lock assembly is a mortice lock assembly. That is, the lock assembly is intended to be installed within a mortice of a panel, such as a door or a window.

The lock assembly has a body 110 for holding components of the lock assembly and a cover 111 for closing the body 110. The body 110 and cover 111 can be coupled using fasteners 112, such as rivets. The cover 111 has a drive hub aperture 113 for allowing access to a drive hub 130, a daylatch aperture 114 for allowing access to a daylatch hub 140, a lock cylinder aperture 115 for allowing access to a lock cylinder 210, and a deadbolt restrictor aperture 116 for allowing access to a deadbolt restrictor 180.

A forend plate 120 is provided at one longitudinal end of the body 110. This may be affixed to the body 110 by fasteners 121, such as screws. The forend plate 120 has a deadbolt aperture 122 for allowing passage of a deadbolt 220 and a latch aperture 123 for allowing passage of a latch 230.

A fastener 124 may pass through the forend plate 120 into the lock cylinder 210 to mount the lock cylinder 210 to the lock assembly. Fasteners may pass through holes 125 to mount the forend plate 120 (and consequently the lock assembly) to a forend of a door.

In use, the deadbolt 220 and the latch 230 may engage with a strike plate on a door frame. Each of the latch 230 and the deadbolt 220 can be inserted into corresponding cavities of the strike plate. When this occurs, the latch 230 and/or the deadbolt 220 prevent, or at least impede, the door from opening. The deadbolt 220 may be retracted, for example by a key in the lock cylinder 210 being turned. The latch 230 may be retracted, for example by a handle being turned. The daylatch hub 140 may prevent the handle from being operated, at least in one direction. In addition, a latch locking plate 233 may be provided in communication with the deadbolt, such that when the deadbolt is extended, the latch locking plate 233 prevents the latch from being retracted.

FIG. 3 shows an isometric view of the internals of the lock assembly with the cover 111 omitted.

The drive hub 130 comprises a central aperture 131 which can receive a spindle of a handle. The central aperture 131 may be keyed, such as by having a square cross-section in the same manner as the spindle. Operation of the handle causes the spindle to rotate, which in turn causes the drive hub 130 to rotate.

The drive hub 130 has an actuator 132 which rotates in concert with the drive hub 130. The actuator 132 is located in an aperture 231 of a latch cam follower 232. The latch cam follower 232 is connected to latch 230 via a fastener, or may otherwise be integral with the latch 230. Rotation of the drive hub 130 in a first rotational direction (such as clockwise) causes the latch 230 to be retracted. A latch bias 133 causes the latch 230 to be extended when a user releases the handle.

The daylatch hub 140 comprises a central aperture 141 which can receive a spindle of a snib. The central aperture 141 may be keyed, such as by having a square cross-section in the same manner as the spindle. Operation of the snib causes the spindle to rotate, which in turn causes the daylatch hub 140 to rotate.

The daylatch hub 140 is in communication with a daylatch plate 142. When the daylatch hub 140 is rotated into an engaged position, the daylatch plate 142 moves to block the drive hub 130 from rotating, at least in the first rotational direction. This requires the daylatch hub 140 to be disengaged before the handle can be operated. The daylatch hub 140 can therefore be accessed on an inside of a door to prevent a user on the outside of the door from operating the handle. This provides a level of security.

The deadbolt 220 moves laterally between a retracted position in which the deadbolt 220 is wholly (or at least substantially) located within the lock body 110, a first extended position in which the deadbolt 220 extends through the deadbolt aperture 122 of the lock body 110 at a first distance, and a second extended position in which the deadbolt 220 extends through the deadbolt aperture 122 of the lock body 110 at a second distance greater than the first distance.

A locking plate 150 is mounted so as to pivot about a pin 151 between a locked position in which the deadbolt 220 cannot move and an unlocked position in which the deadbolt 220 can move. A biasing member 152 (such as a leaf spring) may bias the locking plate 150 towards the locked position.

A first cam follower 240 is connected to, or integral with the deadbolt 220. The first cam follower 240 has a first arm 241 and a second arm 242 descending from an end, which are spaced apart to receive a cam. A post 243 extends transversely from the first cam follower 240.

The post 243 can move through a channel 153 in the locking plate 150. A first recess 154, second recess 155, and third recess 156 are provided off the channel 153. These correspond respectively to the retracted position, first extended position, and second extended position of the deadbolt 220.

A second cam follower 250 is provided on the body 110 of the lock assembly. The second cam follower has a track 251, bounded at one end by an arm 252 and at the other end by a stop 253. The first cam follower 240 is able to move along the track 251. A spring 254 (or other bias means) biases the first cam follower 240 towards the stop 253 opposing the arm 252.

The lock cylinder 210 has a cam 211 which rotates about the lock cylinder 210. This occurs, for example, when a suitable key is inserted into the lock cylinder 210. Rotation of the key rotates the cam 211 in concert.

The cam 211 is positioned to engage with the locking plate 150, and may move the locking plate 150 into the unlocked position by resisting the biasing member 152.

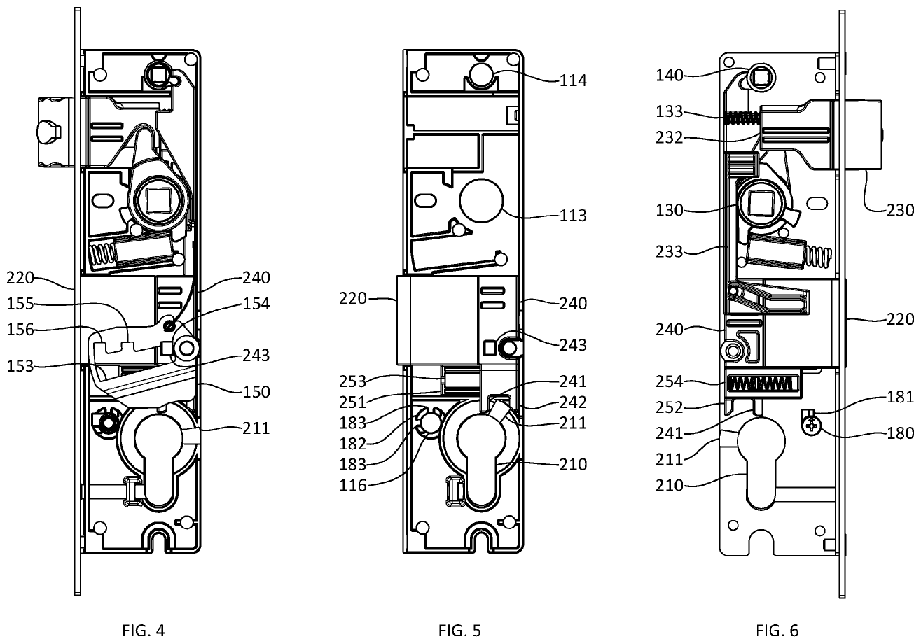

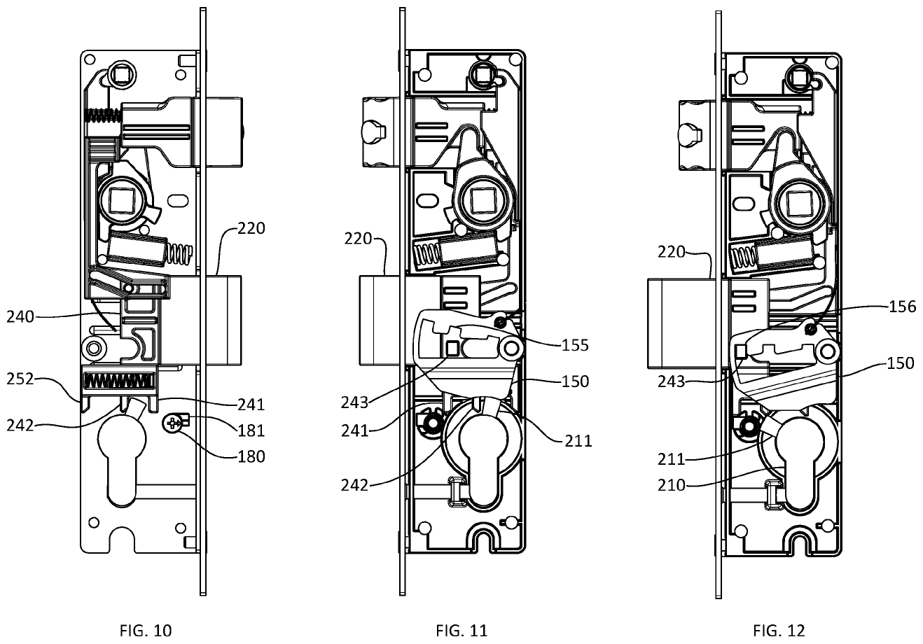

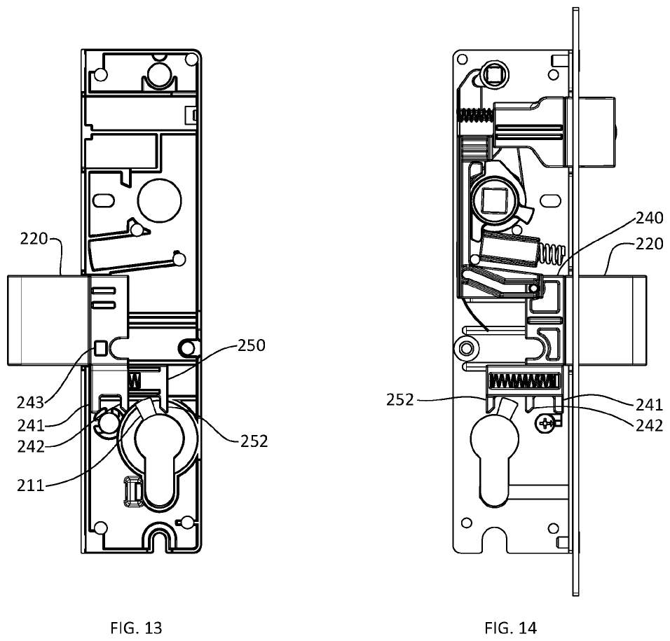

The cam 211 may move the deadbolt 220 between the retracting position and the first extended position through communication with a first arm 241 of a first cam follower 240 of the deadbolt 220. The cam may move the deadbolt 220 from the first extended position to the second extended position through communication with the second arm 242 of the first cam follower 240, and from the second position to the first extended position through communication with the arm 252 of the second cam follower 250. This operation is shown in greater detail in FIGS. 4 to 14.

The lock assembly has a deadbolt restrictor 180 to selectively restrict the level of extension of the deadbolt 220. In particular, the deadbolt restrictor 180 can prevent the deadbolt 220 entering the second extended position. The deadbolt restrictor 180 has an integrally formed restrictor cam 181 which pivots within the body. The deadbolt restrictor 180 moves between a restricted position and an unrestricted position, which may be about 90° apart. When the deadbolt restrictor 180 is in the restricted position, the restrictor cam 181 is in the path of the first cam follower 240. When the deadbolt 220 is in the first extended position, the first cam follower 240 abuts the restrictor cam 181. This impedes further movement of the deadbolt 220 towards the second extended position. When the deadbolt restrictor 180 is in the unrestricted position, the restrictor cam 181 is not in the path of the first cam follower 240. The deadbolt restrictor 180 in the second position does not prevent movement of the deadbolt 220.

The deadbolt restrictor 180 may be selectively rotated between the restricted and unrestricted positions, for example using a tool (such as a hex key) or by a user's finger. The deadbolt restrictor 180 couples with a formation 182 on the body 110 and/or the cover 111. The formation 182 has two recesses 183. A spring (or other bias means) biases the deadbolt restrictor 180 into the recesses 183 in order to prevent the deadbolt restrictor 180 from rotating. In some cases, the deadbolt restrictor 180 may require transverse force before a rotational force can be applied to rotate the deadbolt restrictor 180 to resist the bias of the spring. This allows the deadbolt restrictor 180 to exit one of the recesses 183 and be rotated to alignment with the other recess 183. Each recess may correspond to one of the restricted and unrestricted positions. When the user releases the transverse force, the deadbolt restrictor 180 then re-enters the recess 183. This allows the restrictor cam 181 to resist lateral force from the first cam follower 240 without rotating back into the unrestricted position.

### Retracted Position to First Extended Position

FIGS. 4 to 6 show the lock assembly with the deadbolt 220 in the retracted position. The locking plate 150 is in the locked position and the post 243 is positioned in the first recess 154 of the locking plate 150. The deadbolt 220 therefore cannot move laterally.

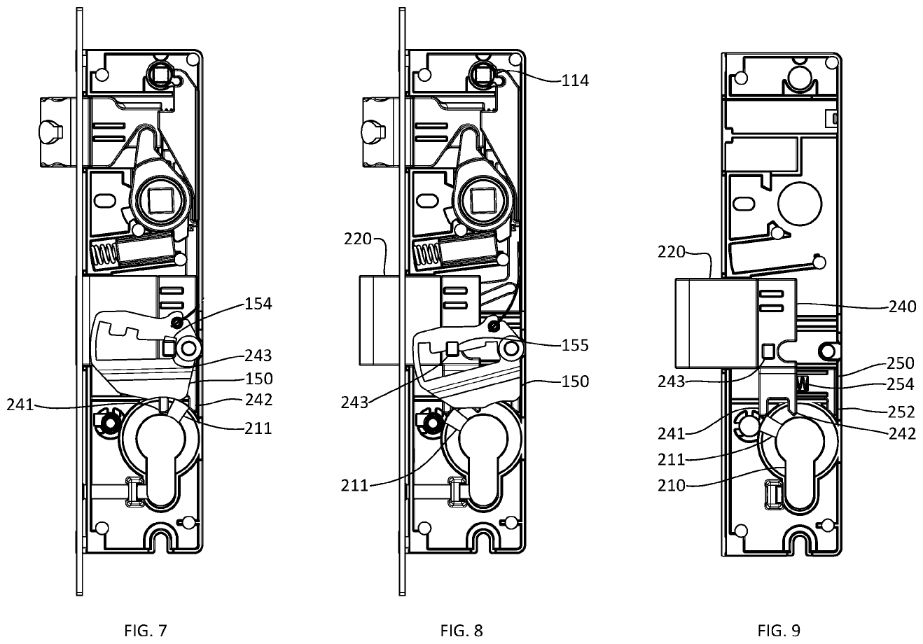

When a user rotates the lock cylinder 210, the lock assembly moves to the state shown in FIG. 7.

The cam 211 enters the first cam follower 240. The second arm 242 of the first cam follower 240 may be bevelled to allow the cam 211 to pass the second arm 242 without contact. As the cam 211 enters the first cam follower 240, the cam 211 pushes against the locking plate 150. This resists the bias of biasing member 152, and causes the locking plate 150 to pivot into the unlocked position. This causes the post 243 to exit the first recess 154.

Further rotation of the lock cylinder 210 causes the lock assembly to move to the state shown in FIGS. 8 to 10.

The cam 211 pushes against the first arm 241 of the first cam follower 240. This moves the first cam follower 240 along the track 251 of the second cam follower 250, which in turn drives the deadbolt 220 to enter the first extended position. The cam 211 then passes out of the first cam follower 240. Because the cam 211 is no longer pushing against the locking plate 150, the biasing member 152 urges the locking plate 150 back into the locked position. The post 243 then enters the second recess 155. The second recess 155 is located such that when the cam 211 moves out of contact with the locking plate 150, the post 243 is aligned with the second recess 155. This prevents further lateral movement of the first cam follower 240.

The movement of the first cam follower 240 removes the compression on the spring 254. The spring 254 retains sufficient tension to maintain the second cam follower 250 in position relative to the first cam follower 240.

In this state, the deadbolt 220 is in the first extended position, and so may engage with a strike plate on a door frame. This may be sufficient to deadlock the door, and therefore may provide sufficient security.

The key may therefore be removed from the lock cylinder 210, optionally after further rotation to return the lock cylinder 210 to a neutral position.

The deadbolt 220 may be moved from the first extended position to the retracted position by rotating the lock cylinder in the opposite direction. The cam 211 forces the locking plate 150 into the unlocked position and pushes against the second arm 242 of the first cam follower 240. This slides the first cam follower 240 along the track 251 of the second cam follower. This in turn moves the deadbolt 220 into the retracted position. As the cam 211 exits the first cam follower 240, the locking plate 150 is urged into the locked position from biasing member 152 and the post 243 enters the first recess 154.

### First Extended Position to Second Extended Position

From the state shown in FIGS. 8 to 10, further rotation of the lock cylinder 210 causes the lock assembly to move to the state shown in FIG. 11. This may require at least a full rotation of the lock cylinder 210.

The cam 211 enters the space between the arm 252 of the second cam follower 250 and the second arm 242 of the first cam follower 240. The arm 252 of the second cam follower 250 may be bevelled to allow the cam 211 to pass the arm 252 without contact. As the cam 211 enters the space, the cam 211 pushes against the locking plate 150. This resists the bias of biasing member 152, and causes the locking plate 150 to pivot into the unlocked position. This causes the post 243 to exit the second recess 155.

Further rotation of the lock cylinder 210 causes the lock assembly to move to the state shown in FIGS. 12 to 14.

The cam 211 pushes against the second arm 242 of the first cam follower 240. This pushes the first cam follower 240, which in turn drives the deadbolt 220 to enter the second extended position. In addition, the first cam follower 240 pushes against the stop 253 of the second cam follower 250, which causes the second cam follower 250 to move laterally in concert with the first cam follower 240. The cam 211 then passes out of the space between the arm 252 of the second cam follower 250 and the second arm 242 of the first cam follower 240. Because the cam 211 is no longer pushing against the locking plate 150, the biasing member 152 urges the locking plate 150 back into the locked position. The post 243 then enters the third recess 156. The third recess 156 is located such that when the cam 211 moves out of contact with the locking plate 150, the post 243 is aligned with the third recess 156. The locking plate 150 therefore prevents the first cam follower 240 from moving laterally, and the spring 254 prevents the second cam follower 250 from moving relative to the first cam follower 240.

In this state, the deadbolt 220 is in the second extended position. This may cause the deadbolt 220 to engage with a strike plate on a door frame (if, in the first extended position, there remains a gap), or to further enter the strike plate.

The key may therefore be removed from the lock cylinder 210, optionally after further rotation to return the lock cylinder to a neutral position.

The deadbolt 220 may be moved from the second extended position to the first extended position by rotating the lock cylinder in the opposite direction. The cam 211 forces the locking plate 150 into the unlocked position and pushes against the arm 252 of the second cam follower 250. This moves the second cam follower 250 laterally. In addition, due to the stop 253 and the spring 254,the first cam follower 240 and consequently the deadbolt 220 are moved laterally in concert with the second cam follower 250. This moves the deadbolt 220 into the first extended position. As the cam 211 exits the space between the arm 252 of the second cam follower 250 and the second arm 242 of the first cam follower 240, the locking plate 150 enters the locked position and the post 243 enters the second recess 155. The locking plate 150 therefore prevents the first cam follower 240 from moving laterally, and the spring 254 prevents the second cam follower 250 from moving relative to the first cam follower 240.

### Restrictor

FIGS. 4 to 14 show the deadbolt restrictor 180 in the unrestricted position. In this position, the deadbolt restrictor 180 does not prevent the deadbolt 220 from entering the second extended position.

However, in some cases, it may be desirable to restrict the deadbolt 220 from entering the second extended position. One situation may be if a deadbolt recess in the door frame is too shallow to accommodate the deadbolt 220 in its second extended position. To avoid the need to reassemble the lock assembly with a different deadbolt size, the deadbolt restrictor 180 may be set into the restricted position.

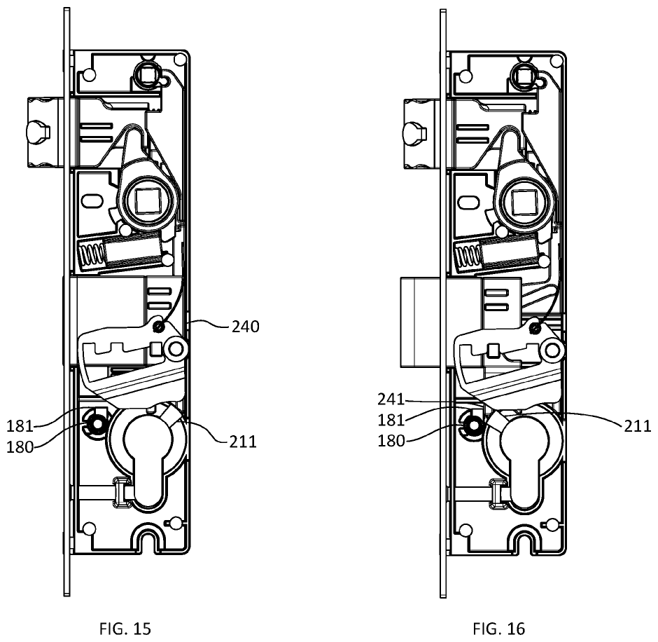

FIG. 15 is similar to FIG. 4, except with the deadbolt restrictor 180 in the restricted position. The restrictor cam 181 is aligned with the path of the first cam follower 240. However, because the deadbolt is in the retracted position, the restrictor cam 181 does not abut the first cam follower 240. The deadbolt restrictor 180 therefore does not prevent the deadbolt 220 from moving between the retracted position and the first extended position.

FIG. 16 is similar to FIG. 8, except with the deadbolt restrictor 180 in the restricted position. The transition between FIGS. 15 and 16 is therefore the same as between FIGS. 4 and 8.

The restrictor cam 181 is aligned with the path of the first cam follower 240. The restrictor cam 181 may abut the first arm 241 of the first cam follower 240 in this position, or may abut the first arm 241 of the first cam follower 240 on further movement of the deadbolt 220 towards the second extended position.

The restrictor cam 181 resists the force of the cam 211 on the second arm 242 of the first cam follower 240. Rotating the lock cylinder therefore does not cause the deadbolt 220 to move from the first extended position to the second extended position.

In this way, a single lock assembly can be used for multiple configurations of door frame.

### Interpretation

The discussion of any existing technology should not be construed as an admission that such technology forms part of the common general knowledge.

The term “comprises” and other grammatical forms is intended to have an inclusive meaning unless otherwise noted. That is, they should be taken to mean an inclusion of the listed components, and possibly of other non-specified components or elements.

The present invention has been illustrated by the description of some embodiments. While these embodiments have been described in detail, this should not be taken to restrict or limit the scope of the claims to those details.

Additional advantages and modifications will readily appear to those skilled in the art. Therefore, the invention in its broader aspects is not limited to the specific details of the illustrative examples shown and described. Accordingly, modifications may be made to the details without departing from the spirit or scope of the general inventive concept.

What is claimed is:

1. A lock assembly, comprising:
a lock cylinder comprising a cam;
a deadbolt comprising a first cam follower and a second cam follower, each of the first cam follower and the second cam follower being configured to receive the cam;
wherein rotation of the lock cylinder in a first rotational direction causes the cam to communicate with the first cam follower to drive the deadbolt from a retracted position to a first extended position, and further rotation of the lock cylinder in the first rotational direction causes the cam to communicate with the first cam follower to drive the deadbolt from the first extended position to a second extended position;
wherein rotation of the lock cylinder in a second rotational direction opposite to the first rotational direction causes the cam to communicate with the second cam follower to drive the deadbolt from the second extended position to the first extended position, and further rotation of the lock cylinder in the second rotational direction causes the cam to communicate with the first cam follower to drive the deadbolt from the first extended position to the retracted position; and
wherein the lock assembly further comprises a deadbolt restrictor movable between a restricted position and an unrestricted position, wherein in the restricted position, the restrictor impedes the deadbolt from moving from the first extended position to the second extended position, and in the unrestricted position, the restrictor does not impede the deadbolt from moving from the first extended position to the second extended position.

2. The lock assembly of claim 1, wherein the first cam follower comprises a first arm and a second arm, and the second cam follower comprises an arm;
the cam communicating with the first cam follower to drive the deadbolt from a retracted position to a first extended position comprises the cam pushing against the first arm of the first cam follower;
the cam communicating with the first cam follower to drive the deadbolt from the first extended position to the second extended position comprises the cam pushing against the second arm of the first cam follower;
the cam communicating with the second cam follower to drive the deadbolt from the second extended position to the first extended position comprises the cam pushing against the arm of the second cam follower; and
the cam communicating with the first cam follower to drive the deadbolt from the first extended position to the retracted position comprises the cam pushing against the second arm of the first cam follower.

3. The lock assembly of claim 1, wherein the second cam follower comprises a track, and the first cam follower is configured to slide along the track to move relative to the second cam follower.

4. The lock assembly of claim 3, further comprising a bias means configured such that when the deadbolt is in the first extended position or the second extended position, the bias means resists movement of the first cam follower relative to the second cam follower.

5. The lock assembly of claim 1, further comprising a locking plate, the locking plate comprising a channel and a plurality of recesses; wherein the first cam follower comprises a post configured to move within the channel of the locking plate and to sit within each of the recesses.

6. The lock assembly of claim 5, wherein when the post is within a first recess, the deadbolt is in the retracted position, when the post is within a second recess, the deadbolt is in the first extended position, and when the post is within a third recess, the deadbolt is in the second extended position.

7. The lock assembly of claim 5, wherein the locking plate is movable between a locked position and an unlocked position, wherein when the locking plate is in the locked position, the locking plate impedes the deadbolt from moving between the retracted position and the first extended position or between the first extended position and the second extended position, and when the locking plate is in the unlocked position, the locking plate does not impede the deadbolt from moving between the retracted position and the first extended position or between the first extended position and the second extended position.

8. The lock assembly of claim 7, wherein when the cam communicates with the first cam follower or the second cam follower, the locking plate is in the unlocked position.

9. The lock assembly of claim 7, wherein the locking plate is biased towards the locked position.

10. (canceled)

11. The lock assembly of claim 1, wherein ovmg the deadbolt restrictor between the restricted and unrestricted positions comprises a transverse force and a rotational force.
